(19) United States
(12) Patent Application Publication
(10) Pub. No.: US 2013/0213559 A1
(43) Pub. Date: Aug. 22, 2013

(54) SYSTEM AND METHOD FOR DECENTRALIZED MANUFACTURE OF NEW TIRES ENABLING IMPROVED PERFORMANCE CHARACTERISTICS

(71) Applicant: Scott Damon, Brentwood, TN (US)

(72) Inventor: Scott Damon, Brentwood, TN (US)

(21) Appl. No.: 13/760,098

(22) Filed: Feb. 6, 2013

Related U.S. Application Data
(60) Provisional application No. 61/595,969, filed on Feb. 7, 2012.
(60) Provisional application No. 61/595,980, filed on Feb. 7, 2012.
(60) Provisional application No. 61/595,985, filed on Feb. 7, 2012.
(60) Provisional application No. 61/595,987, filed on Feb. 7, 2012.
(60) Provisional application No. 61/595,990, filed on Feb. 7, 2012.
(60) Provisional application No. 61/595,997, filed on Feb. 7, 2012.

(51) Int. Cl. B29D 30/08

(52) U.S. Cl. CPC B29D 30/08
USPC 156/123; 156/394.1

(57) ABSTRACT

Systems and methods for decentralized tire manufacturing permit the pre-selection of properties of a new casing by individually selecting properties of the casing. The components and raw materials are pre-selected to provide improved and individualized performance characteristics when combined with separately-manufactured new cured tire treads. The new cured treads are manufactured separately in such a manner that pre-selected processing and raw materials may be used to selectively improve performance characteristics. The pre-selected materials and processing used in the separate manufacture of the cured treads from the casing are chosen so as to provide an improved final result that is coordinated through the pre-selections. In this manner, a final tread-casing combination can be made in such a way as to improve one or more performance properties of a final tire.

### CROSS-REFERENCE TO RELATED APPLICATIONS

This patent application claims the benefit of priority to:
(1) U.S. Provisional Patent Application No. 61/595,969, filed on Feb. 7, 2012, and entitled “System and Method for Decentralized Manufacture of New Tires Enabling Improved Performance Characteristics”;
(2) U.S. Provisional Patent Application No. 61/595,980, filed on Feb. 7, 2012, and entitled “System and Method for Customizing Vehicle Tires on Demand at Point-of-Sale”;
(3) U.S. Provisional Patent Application No. 61/595,985, filed on Feb. 7, 2012, and entitled “System and Method for Reducing Point-of-Sale Tire Inventory”;
(4) U.S. Provisional Patent Application No. 61/595,987, filed on Feb. 7, 2012, and entitled “System and Method for Tracking Inventory of Tire Components at Point-of-Sale Facility”;
(5) U.S. Provisional Patent Application No. 61/595,990, filed on Feb. 7, 2012, and entitled “System and Method for Pricing, Leasing and Transferring Ownership of Tires”; and
(6) U.S. Provisional Patent Application No. 61/595,997 , filed on Feb. 7, 2012, and entitled “System and Method for Customizing and Manufacturing Tires Near Point-of-Sale,”
   which are incorporated in their entireties herein by this reference.

### BACKGROUND OF THE INVENTION

A new tire is constructed from many separate components including typically a tread, subtread, undertread, reinforcing belts or belt plies, sidewalls, abrasion strips, beads, bead fillers, one or more body plies and a relatively air-impermeable inner liner. The components are themselves constructed from different raw materials such as different rubber compounds, fibrous cords, steel belts, etc. The rubber compounds are typically made of differing formulations including different natural and synthetic rubbers and chemical additives. Such rubber compounds and the other raw materials used in the components have different physical properties that can affect the performance of the new tire. Further, such physical properties often change as a result of the manufacturing process used with the development of the rubber compounds and in the forming and curing of the new tire.

The components of a new tire are conventionally brought together on a tire builder. A new tire is typically built on a drum by first wrapping the drum with the inner liner. The first body ply is then wrapped on top followed by the second body ply. The bead assemblies are then brought into position on the outside of the inner liner and body plies. The inner liner and the body plies are then typically forced to roll over onto the bead assemblies. The sidewalls are also pressed into position.

Next, steel belts, a nylon cap ply, a tread, etc. are applied to the assembly. The tread also may have associated with it, a subtread and an undertread. The final assembly forms a green tire. The green tire is then subjected to heat and pressure which causes a chemical reaction between the rubber and the additives to vulcanize the rubber and bond the assembly together. As an assembly of different materials and compounds, each component affects the final properties of the new tire.

As a result of the variation in new tire performance characteristics that occurs through factors such as the composition of raw materials and the processing and assembly of the tires, the manufacture of tires is typically centralized in a new tire manufacturing plant. By centralizing the manufacture, the manufacturer is able to maintain control over the assembly of the components into green tires, and the processing and curing of those green tires to form new tires.

By controlling the components and the manufacturing process, new tire manufacturers are able to effect changes in performance such as relating to wear, weather performance, rolling resistance, noise, etc. These performance characteristics are subject to multiple variations that are attractive to customers. Since there are many attractive performance characteristics, new tire manufacturers often make many different versions of tires. Further, customers demand different sizing and other physical variations. The result is that the inventory of new tires made at a central manufacturing facility can grow to be very large, in the order of one hundred different versions of tires. Such multiple variations of tires are then delivered to stores where they may be inventoried until they are purchased and installed.

Much work has been done in attempts to improve the efficiency and properties of green tires including the casing of such green tires. However, such processes and methods of manufacturing green tires, and the resultant new tires, have certain limitations including that the green tire is processed and manufactured as a whole. Such prior systems have failed to overcome the inherent limitations that are imputed to the process because some processes are beneficial for some parts of the green tire, but detrimental to others.

Borrowing from the retreading process for worn treads, some have suggested that a retreading process could be applied to a new tire. See, e.g., U.S. Patent Application Publication Nos. U.S. 2009/0183812 (“Universal Body-Support For Pneumatic Tread”) and U.S. 2009/0203278 (“Separate Toroidal Body Support For Pneumatic Coverings”). However, such processes do not provide any means for improved performance characteristics. At best, such retreading simply reconstructs an original tire. At worst, such processes might compromise the performance characteristics by mismatching components. Furthermore, such suggestions fail to address or overcome problems that arise in the combinations of treads with varying physical dimensions with a standard casing. No synergies are possible because there is no improvement of properties that are preselected to coincide and amplify individual properties. The result fails to recognize improved performance characteristics and therefore provides further support for the notion that manufacture of new tires should be centralized and carefully controlled. Since there is no pre-selected improvement process, there is no optimized combination possible that results in a tire with improved properties. As a result, such efforts tended to develop methods that would lead to deficient design and manufacture of tires.

### SUMMARY OF THE DISCLOSURE

In one embodiment, a decentralized tire manufacturing system is described. A casing manufacturing facility is adapted to manufacture a set of different types of cured casings. A tread manufacturing facility is adapted to manufacture a set of different types of cured treads. An assembly facility is adapted to assemble multiple tread-casing combinations to for new tires made from the different types of cured casings and the different types of cured treads. Each type of cured casing is made so as to be specifically made for combination with at least one type of the set of different types of cured treads to provide a new tire with a desired tire characteristic.

In another embodiment, a method of decentralized tire manufacturing is described. A casing is made that has casing properties pre-selected to create a cured casing configured for combination with at least one type of cured tread. The casing is cured using a first curing profile to form the cured casing. A tire tread is separately made that has tread properties pre-selected to create a cured tread configured for combination with the cured casing to form a new tire with a desired tire characteristic. The tire tread is cured using a second curing profile to form the cured tire tread. The cured casing and the separate cured tread are delivered to an assembly facility. The cured casing and the cured tread are combined at the assembly facility to form the new tire with the desired tire characteristic.

Further and alternative aspects and features of the disclosed principles will be appreciated from the following detailed description and the accompanying drawings. As will be appreciated, the principles related to systems and methods for decentralized tire manufacturing disclosed herein are capable of being carried out in other and different embodiments, and capable of being modified in various respects. Accordingly, it is to be understood that the foregoing general description and the following detailed description is exemplary and explanatory only and does not restrict the scope of the disclosed principles.

### BRIEF DESCRIPTION OF THE SEVERAL VIEWS OF THE DRAWINGS

FIGS. 1A-C are a graphical schematic representation of an exemplary new casing manufacturing process.

FIG. 2 is a graphical schematic representation of an exemplary new casing manufacturing process.

FIGS. 3A-C are a graphical schematic representation of an exemplary new casing manufacturing process.

FIG. 4 is a graphical schematic representation of an exemplary intermediate, in transverse section, in a new casing manufacturing process.

FIG. 5 is a graphical schematic representation of an exemplary new casing.

FIGS. 6A-B are graphical schematic representations of exemplary new casings.

FIG. 7 is a graphical schematic representation of exemplary new tread.

FIG. 8 is a graphical schematic representation of an exemplary new tire manufacturing process including decentralization.

FIG. 9 is a graphical schematic representation of an exemplary new tire manufacturing process including decentralization.

FIG. 10 is a graphical schematic representation of an exemplary new tire manufacturing process.

### DETAILED DESCRIPTION OF PREFERRED EMBODIMENTS

In one exemplary embodiment, a decentralized tire manufacturing process is provided which permits the pre-selection of properties of a new casing by individually selecting properties of the casing. Such pre-selected processing and properties are facilitated by the separate and decentralized manufacture of a green casing. The components and raw materials of the green casing are chosen and assembled under pre-selected conditions that facilitate enhanced performance of a final new tire. The components and raw materials are pre-selected to provide improved and individualized performance characteristics when combined with separately-manufactured new tire treads. The new tire treads are manufactured separately in such a manner that pre-selected processing and raw materials may be used to selectively improve performance characteristics. The pre-selected materials and processing used in the separate manufacture of the tire treads from the casing are chosen so as to provide an improved final result that is coordinated through the preselections. In this manner, a final combination of tire tread and casing can be made in such a way as to improve one or more performance properties of a final tire.

To facilitate the improved manufacture of new tires, the manufacturing of the components is decentralized so that treads and casings are brought together for the customer on or near location. The raw materials and the manufacturing processes for the tire treads and the casings are pre-selected and coordinated so that the final improved performance characteristics are quantified and provided to the customer or service representative as part of the selection process for the final tire manufacture.

Further, the separate manufacture of the tire tread and the casing permits for inventory of the separate new tire components to be maintained. Since the inventory is separately maintained, supply can be controlled based upon the characteristics that are being selected by the customers or service representatives. For example, based on the pre-selection of properties in the separate manufacture of the treads from the casings, the final combination can provide improved performance characteristics that would not be possible if the tread and the casing were not manufactured separately. Further, since the raw materials and the processing for the separate parts are pre-selected to provide complementary predetermined combinations, the ultimate performance characteristics of the tires may be maintained.

By coordinating the pre-selection of the improved properties of the various components of the new tire, the inventory is controlled to provide for maximum interaction towards improved performance characteristics. As a result of the decentralized manufacture and the pre-selection, the inventory of a given service outlet can be improved so as to reduce unutilized inventory. For example, a given placement of new tires may be chosen to provide a given selection of performance characteristics such as noise, wear, skid, etc. These properties are determined and potentially improved by the manner in which the new tire and its components are manufactured. Manufacturing the tread and the casing separately permits the pre-selected improvement of their respective characteristics. In an exemplary embodiment, the processing and raw materials for the components are pre-selected so that their ultimate combination provides for a desired improved performance characteristic. Furthermore, the variations of the pre-selected properties are determined so that the combinations are improved.

In contrast to typical green tire manufacture, the raw materials and the processing of an exemplary embodiment includes the selection of raw materials and processing that would be detrimental to other components of the tire. For example, the vulcanization and curing of a green tire may be optimized for the casing or the tire tread. Since the optimization of one often results in some detriment to the other, a unitary green tire is usually cured and vulcanized in a manner that is a compromise. In an exemplary embodiment, such processing conditions are separately optimized.

Further, in an exemplary embodiment, the separate processing is not done entirely separately, disregarding other processing characteristics and other manufacturing selections, such as raw materials and other components. Instead, the processing and materials selections are pre-selected to provide improved combinations with components that are also developed under preselected conditions. This offers the unexpected and significant advantage that the resulting new tires are of improved performance characteristics which may be beyond the characteristics that result from entirely separately manufactured components might offer. As a result, new tires of an exemplary embodiment have pre-determined improved performance characteristics.

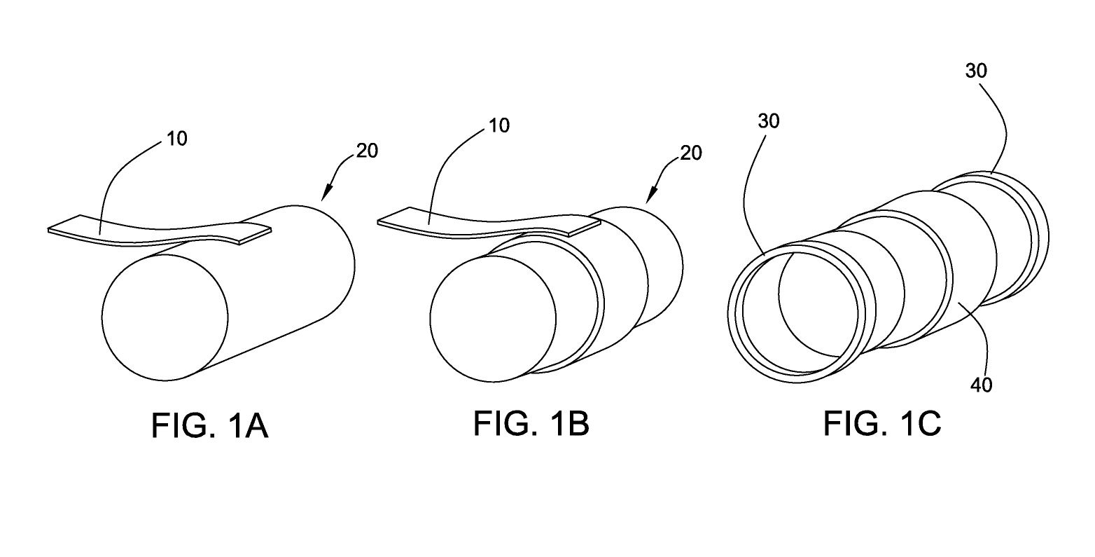

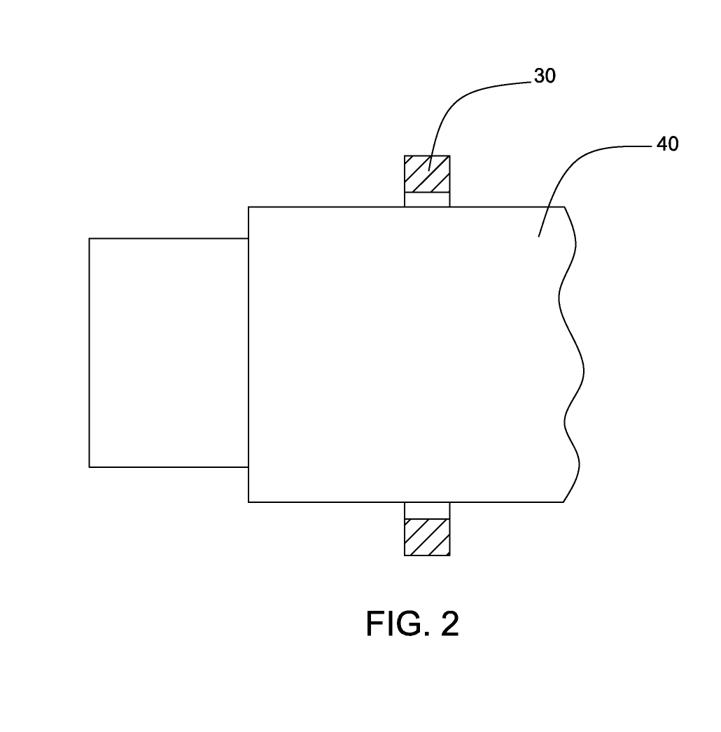

Turning now to the Figures, there is shown in FIGS. 1 (A, B, C), 2, and 3 (A, B, C) an exemplary embodiment where components 10 of a green casing are placed upon a tire builder 20, The raw materials for the components are pre-selected on the basis of ultimate combinations with tire treads that are separately manufactured. As shown in FIG. 1B, multiple components 10 may be wrapped upon the tire builder 20. As shown in FIG. 1C, a bead 30 is brought into place over the component assemblage 40 on the tire builder 20. As depicted in FIG. 2, the ends of the component assemblage 40 are wrapped over the bead 30. Each of the raw materials used in the component assemblage 40 and the bead materials are pre-selected in order to improve performance in combination with a separately-manufactured and cured tire tread.

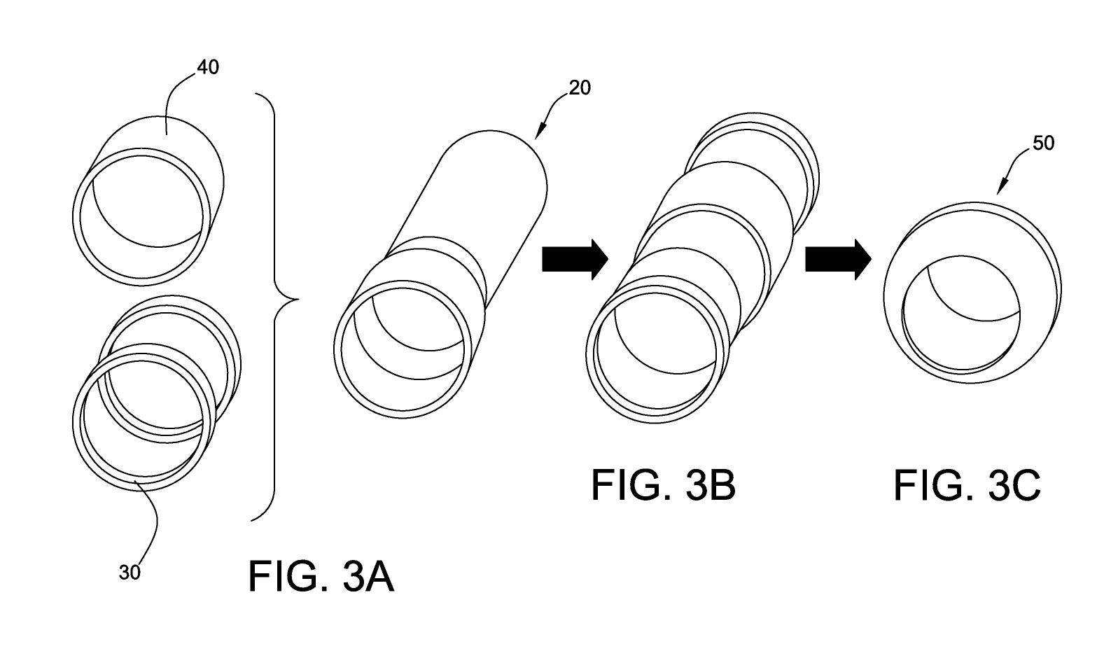

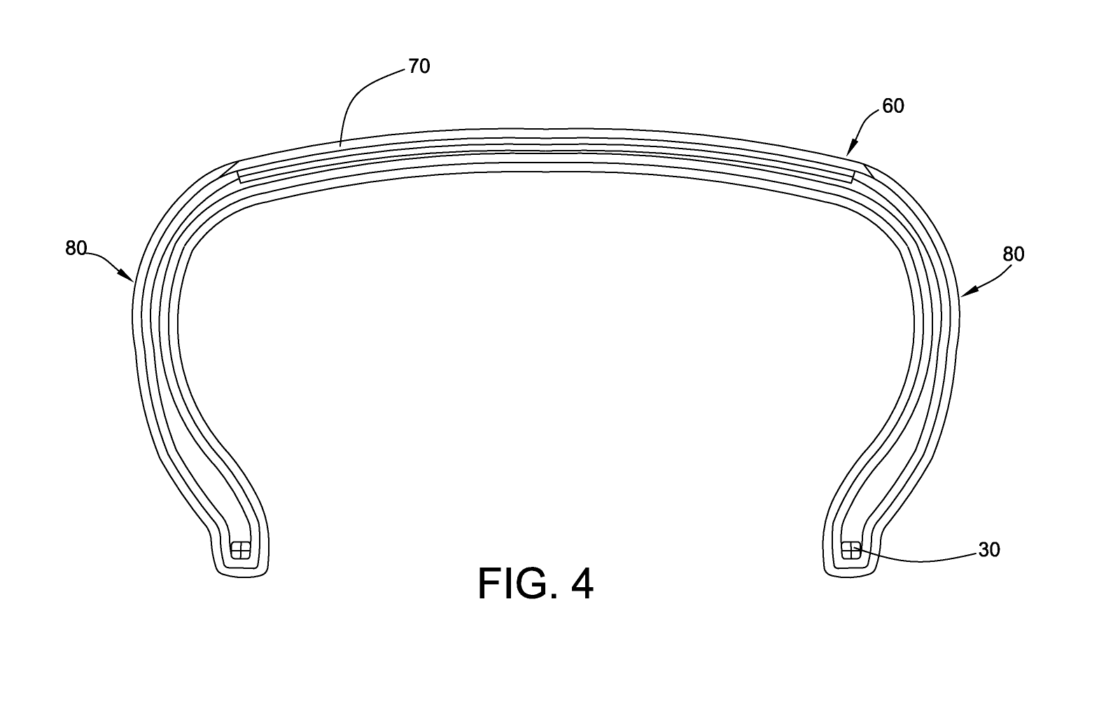

As depicted in FIGS. 3A-C, after the component assemblage is wrapped over the beads 300, the materials are inverted to make a green intermediate 50. The green intermediate then receives further components such as undertread, reinforcing belts, or belt plies, etc. These materials for a green casing which is depicted in FIG. 4. The outermost layer 70 of the green casing 60 between the sidewalls is formed in a pre-selected manner in light of tire treads that will be joined in decentralized manufacture. For example, in one exemplary embodiment the outermost layer 70 of the green casing 80 is provided with a thickness that is much larger than might otherwise be utilized in a new green tire manufacture. Such pre-selection facilitates the improved properties and performance characteristics for the new tire. The thickness may be selected so that depending upon the thickness of the separately manufactured treads, the profile of the tire (i.e., the outer diameter) may be maintained at a predetermined level.

In tire manufacture, the proper alignment and assembly of the components can be significant so that such pre-selection provides significant advantages relating to feasibility of the final new tire. Specifically, new tire profiles that are inconsistent or fail to meet predetermined specifications can result in unusable tires.

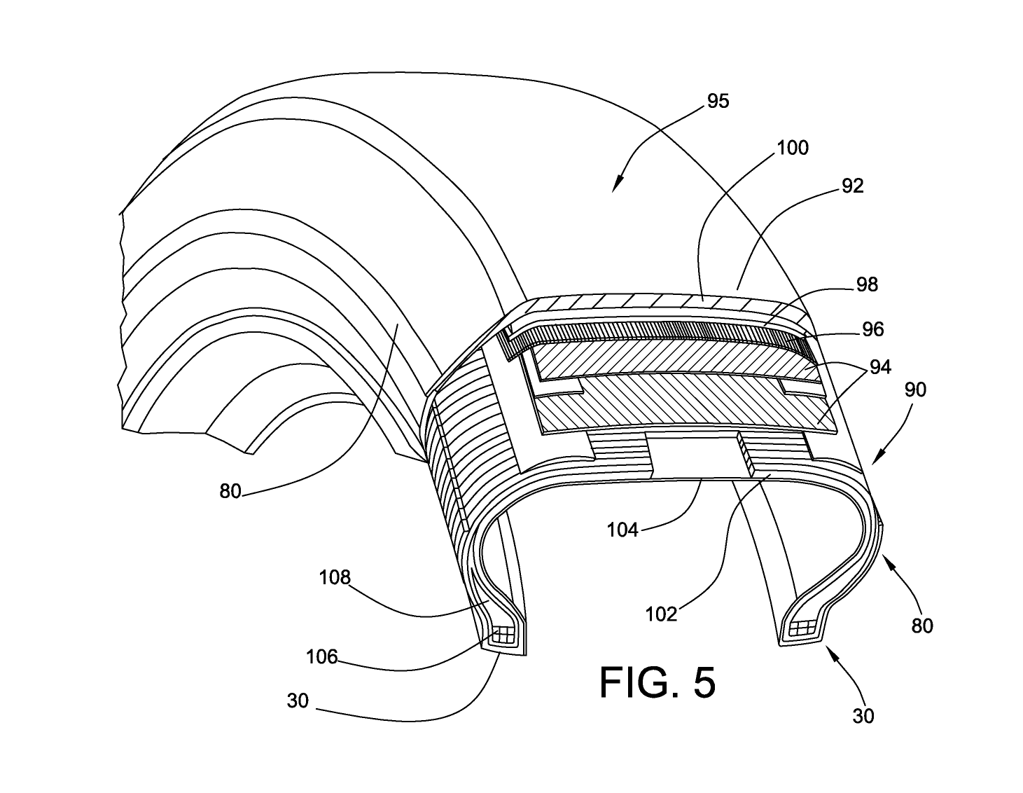

FIG. 5 is a breakaway of the components of an exemplary embodiment of a casing 90 formed by curing the green casing 80. The casing 90 includes such components as a crown area 100 (where the separately-manufactured cured tread is ultimately located) 92, sidewall areas 80 and bead areas 30. The crown area 95 may include multiple distinct components such as steel belts 94, a nylon cap ply 96, a subtread 98 and an undertread 100 for example. The casing 90 also includes a body ply 102 and an inner liner 104. The bead area 30 may include among other components a steel bead bundle 106 and a bead filler 108. These components are selected and processed in a manner preselected to improve performance characteristics when joined with treads separately manufactured.

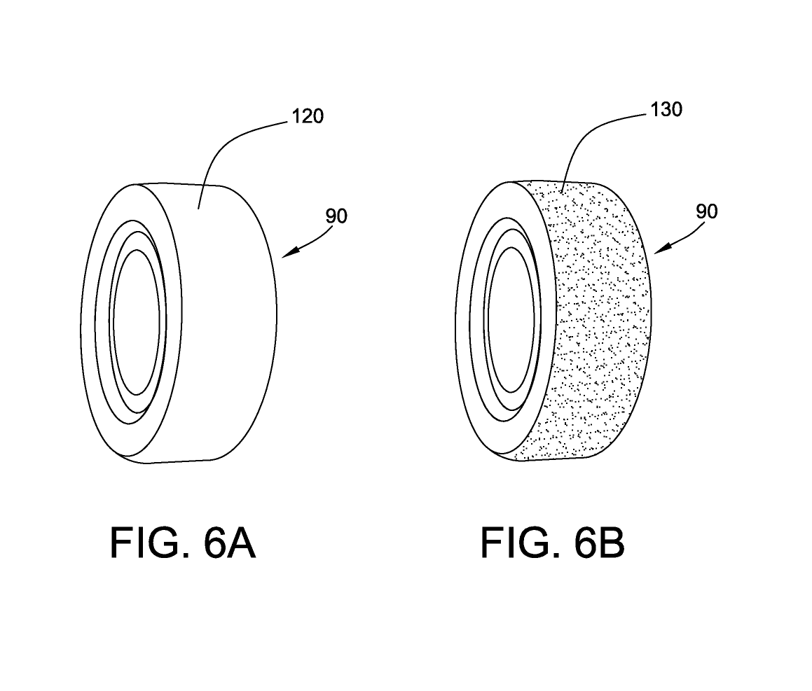

In addition to utilization of specialized manufacturing processes such as utilizing increased or decreased curing temperatures and modifying characteristics of the green and final casing, in some embodiments, other characteristics can be modified. For example, as shown in FIG. 6A and FIG. 6B, the outer surface of layer 70 may be specially treated so as to enhance the interrelationship with similarly-treated or compatibly-treated tire treads. The surface 120 of the casing 90 may be a substantially smooth surface 120 or, in other embodiments, have a surface 130 of varying degrees of roughness. In some embodiments, the smooth surface 120 can be converted to the rough surface 130 using an operational step, such as, buffing, for example. Furthermore, other properties can be modified in conjunction with properties from separately manufactured tire treads including surface modifications and other improvements.

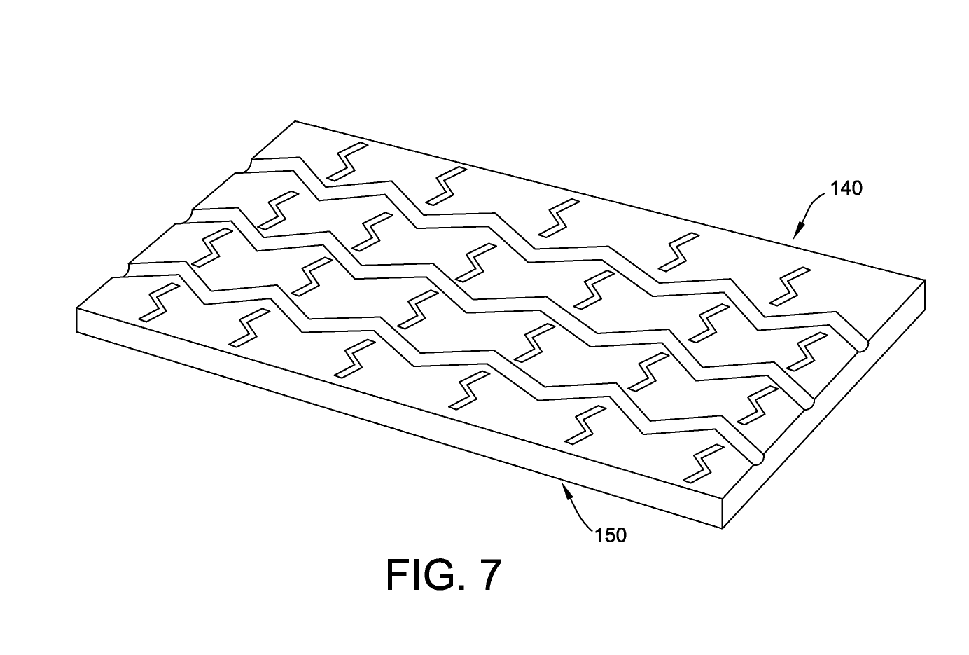

FIG. 7 depicts an exemplary tire tread 140, which is itself separately manufactured with preselected materials and processes to optimize ultimate assemblage with one or more casings 90. In particular, the tire tread 140 can, in some embodiments, undergo alternative processing such as vulcanization and curing under different heating parameters and/or with different additives from the green casing. In this manner, properties of the resulting cured tread 104 can be improved, particularly when combined with pre-selected, separately manufactured casings which have been specially-made for combination with that tread (and, in some embodiments, with a set of different types of treads). In addition to pre-selecting processing parameters, the tire tread 140 may include an underside 150 that has modified properties that are pre-selected to complement one or more casings to promote the bonding between the tread and the casing and/or to enhance one or more performance characteristic. Such parameters may include, for example, surfaces of differing roughness determined in relation to the surfaces such as in relation to the casing surfaces 120 and 130.

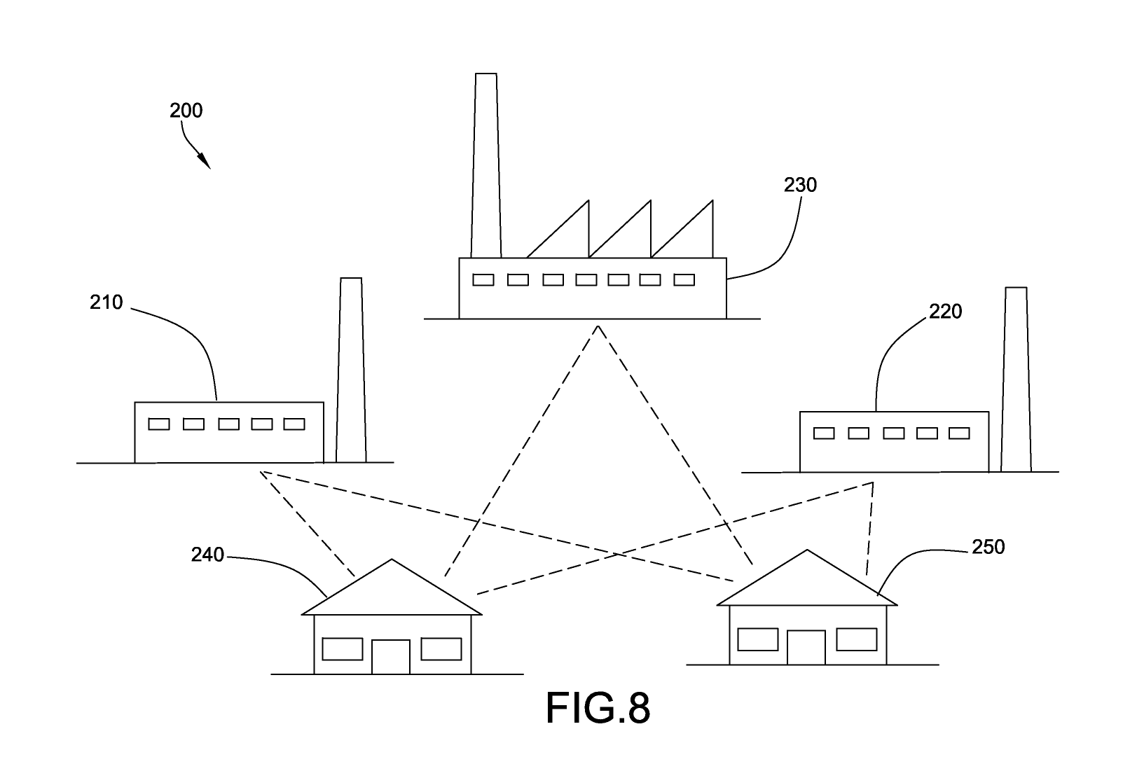

Referring to FIG. 8, an embodiment of a decentralized, distributed tire manufacturing system 200 is shown. A casing manufacturing facility 210 is configured to make a set of different types of cured casings. Each type of casing can be made so as to be specifically made for combination with at least one type cured tread to provide enhanced performance characteristics, and in some embodiments with a set of different types of cured treads so that when respectively combined with the different types of cured treads, a new tire is obtained with different enhanced performance characteristics. A tread manufacturing facility 220 is configured to make a set of different types of cured treads. Each type of cured tread can be made so as to be specifically made for combination with at least one type of casing to provide enhanced performance characteristics, and in some embodiments with a set of different types of casings so that when respectively combined with the different types of casings, a new tire is obtained with different enhanced performance characteristics. A single manufacturing facility 230 can comprise both a casing manufacturing facility and a tread manufacturing facility 220 for supplying different types of casings and different types of cured treads made specifically so that certain tread-casing combinations result in new tires with enhance performance characteristics. The casings and treads cam be configured such that certain types of tire casings are combinable with certain types of treads to produce finished tires having customizable performance characteristics.

The exemplary decentralized tire manufacturing system 200 includes a pair of assembly facilities 240, 250, which are both configured to assemble various tread-casing combinations received from the manufacturing facilities 210, 220, 230 and form new tires therefrom. In some embodiments, on or more of the assembly facilities 240, 250 can be associated with a point-of-sale facility which is in the form of a brick-and-mortar storefront in which a customer can purchase a custom-selected tire for on-demand assembly by the facility using a predetermined tread-casing combination to obtain a new tire with the performance characteristics selected by the customer. In other embodiments, the assembly facility can comprise a regional assembly facility which service a number of point-of sale facilities.

In other embodiments, the decentralized tire manufacturing system 200 can include a different number of manufacturing and/or assembly facilities. In still other embodiments, the decentralized tire manufacturing system 200 can include additional facilities as part of the tire supply chain, such as inventory facilities and different kinds of point-of-sale facilities.

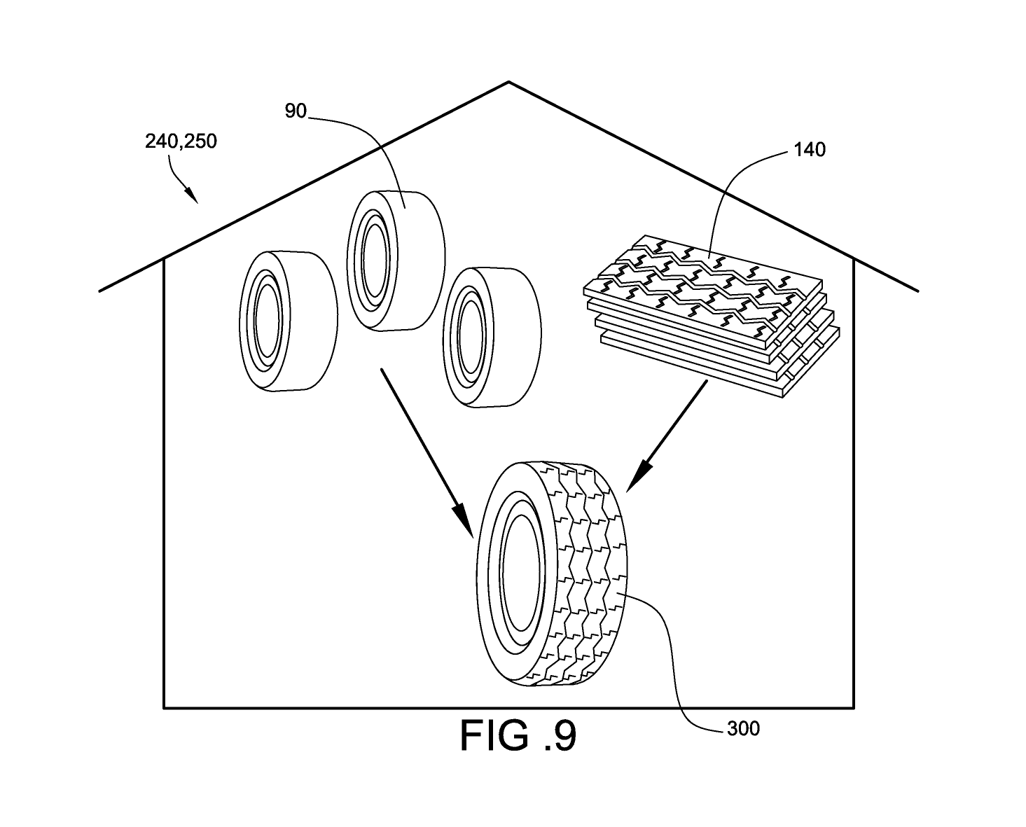

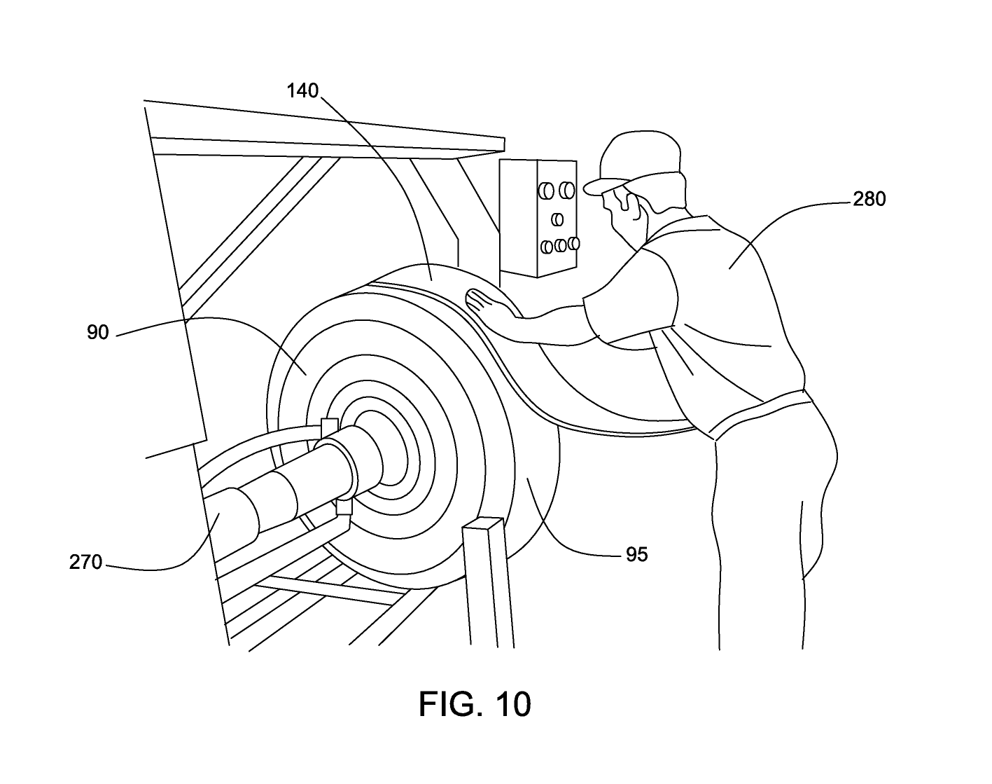

Referring to FIGS. 9 and 10, each assembly facility 240, 250 can include various machines, including a tire builder 270, for example, and skilled technicians 280 that can use a predetermined casing 90 and tread 140 to build a new tire 300 having enhanced performance characteristics obtained by the separate manufacture of the casing and the tread. At each assembly facility 240, 250, the casing 90 and the tread 140 are combined in a process that may include various operations, such as buffing of the crown area 95 of the casing 90 to remove oxidation, deposition of cushion gum on the crown area 95 of the casing 90, fitting, pressing and stitching of the tread 140 around the casing 90, and the like. After the tread 140 and the casing 90 have been assembled, the tread-casing combination can undergo a pressing and vulcanization operation to complete the tire 130. A customer can complete a tire transaction with the point-of-sale facility to receive the finished tire.

In some embodiments, the outermost layer 70 of the casing 90 can be made of a thickness that is thicker than a subtread of a conventional tire to accommodate tire treads 140 of varying thicknesses. Different types of tire treads 140 can vary in thickness based on certain performance characteristics related to the tread. To ensure that the final tire 300 is the desired overall size, the outermost layer 70 can be buffed using known buffers to reduce the outer diameter of the casing to that necessary to combine the casing 90 with the selected tread 140 and achieve a new tire 300 having a desired outer dimension. Buffing the excess outermost layer 70 additionally exposes a layer of unoxidized rubber which can promote the seal between the tread 140 and the casing 90.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A decentralized tire manufacturing system comprising:
a casing manufacturing facility adapted to manufacture a set of different types of cured casings;
a tread manufacturing facility adapted to manufacture a set of different types of cured treads;
an assembly facility adapted to assemble multiple tread-casing combinations to for new tires made from the different types of cured casings and the different types of cured treads;
wherein each type of cured casing is made so as to be specifically made for combination with at least one type of the set of different types of cured treads to provide a new tire with a desired tire characteristic.

2. The decentralized, distributed tire manufacturing system of claim 1, wherein each type of cured tread is made so as to be specifically made for combination with at least one type of the set of different types of cured casings to provide a new tire with a desired tire characteristic.

3. The decentralized, distributed tire manufacturing system of claim 2, wherein at least one of the different types of cured treads is made so as to be specifically made for combination with at least one other type of the set of different types of cured casings to provide a new tire with a different desired tire characteristic.

4. The decentralized, distributed tire manufacturing system of claim 1, wherein at least one of the different types of cured casings is made so as to be specifically made for combination with at least one other type of the set of different types of cured treads to provide a new tire with a different desired tire characteristic.

5. The decentralized, distributed tire manufacturing system of claim 1, wherein at least one type of the different types of cured casings includes cured casings with an outer circumferential surface layer treated so as to enhance the interrelationship with at least one type of the different types of cured treads, said cured treads including an underside similarly-treated or compatibly-treated with respect to the outer circumferential layer of the cured casing.

6. The decentralized, distributed tire manufacturing system of claim 1, wherein at least one type of the different types of cured treads includes tire treads having an underside with modified properties that are pre-selected to complement at least one type of the different types of cured casings to promote the bonding between the cured tread and the cured casing in a given tread-casing combination.

7. The decentralized, distributed tire manufacturing system of claim 1, wherein at least one type of the different types of cured casings is made so as to be specifically made for combination with at least one type of different types of cured treads to provide a new tire with a desired tire characteristic, wherein said cured treads include at least one different additive from said cured casings.

8. The decentralized, distributed tire manufacturing system of claim 7, wherein said cured casings include at least one different additive from said cured treads.

9. A method of decentralized tire manufacturing comprising:
making a casing having casing properties pre-selected to create a cured casing configured for combination with at least one type of cured tread;
curing the casing using a first curing profile to form the cured casing;
separately making a tire tread having tread properties pre-selected to create a cured tread configured for combination with the cured casing to form a new tire with a desired tire characteristic;
curing the tire tread using a second curing profile to form the cured tire tread;
delivering the cured casing and the separate cured tread to an assembly facility;
combining the cured casing and the cured tread at the assembly facility to form the new tire with the desired tire characteristic.

10. The method of decentralized tire manufacturing of claim 9, further comprising:
treating an outer circumferential surface layer of the casing so as to enhance the interrelationship of the cured casing with the cured tread.

11. The method of decentralized tire manufacturing of claim 10, further comprising:
with respect to the outer circumferential layer of the cured casing, similarly or compatibly treating an underside of the tread.

12. The method of decentralized tire manufacturing of claim 9, wherein the tread is made with an underside having modified properties that are pre-selected to promote the bonding between the cured tread and the cured casing.

13. The method of decentralized tire manufacturing of claim 9, wherein the tread is made with at least one different additive from the casing.

14. The method of decentralized tire manufacturing of claim 13, wherein the casing is made with at least one different additive from the tread.

15. The method of decentralized tire manufacturing of claim 9, wherein the casing is made with at least one different additive from the tread.

16. The method of decentralized tire manufacturing of claim 9, wherein the first curing profile is different than the second curing profile.

17. The method of decentralized tire manufacturing of claim 9, wherein at least one of the first curing profile and the second curing profile comprises zoned curing.

18. The method of decentralized tire manufacturing of claim 9, further comprising:
after delivering the cured casing and the separate cured tread to the assembly facility and before combining the cured casing and the cured tread at the assembly facility, buffing an outer circumferential surface layer of the casing to form a textured surface.

19. The method of decentralized tire manufacturing of claim 9, wherein the cured casing and the cured tread are combined at the assembly facility to form the new tire with the desired tire characteristic in response to an order from a customer through a point-of-sale facility.

20. The method of decentralized tire manufacturing of claim 19, wherein the assembly facility is located at or within a predetermined distance from the point-of-sale facility.
